(19) United States
(12) Patent Application Publication
(10) Pub. No.: US 2025/0011133 A1
(43) Pub. Date: Jan. 9, 2025

(54) METHOD FOR POSITIONING ELEVATOR MODULES AND AN ELEVATOR ARRANGEMENT

(71) Applicant: Kone Corporation, Helsinki (FI)

(72) Inventors: Aki HAIKONEN, Helsinki (FI); Anssi VENHO, Helsinki (FI); Sakari KORVENRANTA, Helsinki (FI); Vesa TIAINEN, Helsinki (FI); Kai PRUSTI, Helsinki (FI); Mika IJÄS, Helsinki (FI)

(73) Assignee: Kone Corporation, Helsinki (FI)

(21) Appl. No.: 18/891,360

(22) Filed: Sep. 20, 2024

Related U.S. Application Data
(63) Continuation of application No. PCT/EP2022/059750, filed on Apr. 12, 2022.

(51) Int. Cl. B66B 19/00; B66B 11/00

(52) U.S. Cl. CPC B66B 19/002; B66B 11/0005

(57) ABSTRACT

A method for positioning elevator modules in a building, comprising: providing a plurality of prefabricated elevator modules to be installed in a shaft one above the other to form an elevator module stack, the prefabricated elevator modules comprise a prefabricated pit module, one or more prefabricated intermediate modules, and a prefabricated top module; performing a plumbing operation of the shaft; installing said plurality of prefabricated modules such that the hoistway spaces of the prefabricated modules are vertically aligned forming a continuous vertically elongated hoistway where an elevator car can be moved vertically for transporting passengers and/or goods; providing a positioning jig comprising a jig frame with guide means interoperating with guide means receiving members in the bottom of the pit module for guiding the pit module into position relating to the jig and the shaft, determining an installation position for the jig by the plumbing operation and installing the jig in the installation position in the pit of the shaft indicated by the plumbing, and hoisting the pit module onto the jig guided by the guide means. An elevator arrangement.

### CROSS-REFERENCE TO RELATED APPLICATION

This application is a continuation of PCT International Application No. PCT/EP2022/059750 which has an International filing date of Apr. 12, 2022, the entire contents of which are incorporated herein by reference.

### FIELD OF THE INVENTION

The invention relates to a method for positioning elevator modules in a building and an elevator arrangement. The elevator is preferably an elevator for transporting passengers and/or goods.

### BACKGROUND OF THE INVENTION

Conventionally, elevators have been built from components into a prefabricated hoistway or a hoistway is fabricated concurrently with the other parts of the elevator. A drawback has been that all elevator installation work taking place at the construction site consumes time and complicates logistics of the construction site. A drawback has also been that accurate positioning of components has required lots of adjustment at the site. Also, modular elevator solutions have been used, where an elevator is built from several modules.

Modular construction business is increasing trend worldwide and elevator manufacturers need to respond to it. The reason for this is the shorter construction time. Modular construction creates fewer site disturbances and allows for tighter construction. Using traditional construction methods, it can take about a week to build an elevator one floor high vertically inside a building. With traditional elevator installation method, the elevator manufactures are the bottle neck in construction process slowing down the total through put time.

A modular elevator shaft consists of repeated sections called modules. Each prefabricated elevator shaft module typically consists of a steel frame forming the elevator hoistway walls, and elevator components are installed in the frame.

The module-based elevator can be hoisted to the building module by module from top. Related prior solutions have been disclosed in documents EP 0 913 353 A1 and EP 3 747 820 A1, for instance. These documents disclose modular solutions, where an elevator is partly built from several prefabricated modules.

### SUMMARY OF THE INVENTION

The object of the invention is to introduce an improved method for positioning elevator modules in a building and an improved elevator arrangement. An object is to introduce a solution by which one or more of the above defined problems of prior art and/or drawbacks discussed or implied elsewhere in the description can be solved. An object is particularly to provide a solution which ensures an efficient and trouble-free installation with good ride comfort, while maintaining safe working practices.

It is brought forward a new method for positioning elevator modules in a building, comprising: providing a plurality of prefabricated elevator modules to be installed in a shaft one above the other to form an elevator module stack, the prefabricated elevator modules comprise a prefabricated pit module, one or more prefabricated intermediate modules, and a prefabricated top module; performing a plumbing operation of the shaft; and installing said plurality of prefabricated modules such that the hoistway spaces of the prefabricated modules are vertically aligned forming a continuous vertically elongated hoistway where an elevator car can be moved vertically for transporting passengers and/or goods.

The method is characterized by providing a positioning jig comprising a jig frame with guide means interoperating with guide means receiving members in the bottom of the pit module for guiding the pit module into position relating to the jig and the shaft; determining an installation position for the jig by the plumbing operation and installing the jig in the installation position in the pit of the shaft indicated by the plumbing; and hoisting the pit module onto the jig guided by the guide means.

Preferable further details of the invention are introduced in the following, which further details can be combined individually or in any combination.

According to an embodiment the method comprises locking the jig in place to the walls or to the floor of the shaft.

According to an embodiment the method comprises determining straightness of the jig and, if necessary, adding shim plates under the jig.

According to an embodiment the method comprises hoisting a first intermediate module onto the pit module, and supporting and straightening with support legs comprised by the intermediate module frame said first intermediate module to the walls of the shaft.

According to an embodiment the car is pre-assembled in the pit module during hoisting the pit module into the shaft.

According to an embodiment the method comprises hoisting the car from the pit module in an upper portion of the first intermediate module and locking the car in place.

According to an embodiment the method comprises determining the position of the pit module in the pit and adjusting said position with support legs comprised by the frame of the module.

According to an embodiment the method comprises hoisting the remaining intermediate modules, if any, onto the first intermediate module to the position specified by the jig, and supporting and straightening with support legs comprised by the intermediate module frames said intermediate modules to the walls of the shaft.

According to an embodiment the method comprises hoisting the top module onto the uppermost intermediate module, and supporting and straightening with support legs comprised by the top module frame said top module to the walls of the shaft.

According to an embodiment the jig frame has a rectangular shape corresponding to the horizontal cross section of a frame of the pit module.

According to an embodiment the jig frame comprises horizontal beams connected at ends to each other, preferably via corner members comprised by the jig frame.

According to an embodiment the guide means are located in corners of the jig frame, preferably in corner members comprised by the jig frame.

According to an embodiment the guide means comprise vertical guide pins and the guide means receiving members comprise recesses or holes.

According to an embodiment the method comprises using as a support leg a length adjustable mechanism such as a screw, a hinge, a lever, a hydraulic actuator or a pneumatic actuator.

It is also brought forward a new elevator arrangement, comprising:
a plurality of prefabricated elevator modules installed in a shaft one above the other forming an elevator module stack, the prefabricated elevator modules comprising a prefabricated pit module, one or more prefabricated intermediate modules, and a prefabricated top module,
said plurality of prefabricated modules being installed after a plumbing operation of the shaft such that the hoistway spaces of the prefabricated modules are vertically aligned forming a continuous vertically elongated hoistway where an elevator car can be moved vertically for transporting passengers and/or goods.

The arrangement characterized in that the arrangement comprises
a positioning jig comprising a jig frame with guide means interoperating with guide means receiving members comprised by the bottom of the pit module for guiding the pit module into position relating to the jig and the shaft,
the jig being installed in an installation position in the pit of the shaft determined by the plumbing, and
the pit module being guided by the guide means onto the jig and supported by the jig.

Preferable further details of the invention are introduced in the following, which further details can be combined individually or in any combination.

According to an embodiment the jig is locked in place to the walls or to the floor of the shaft.

According to an embodiment the arrangement comprises shim plates added under the jig as a result of determining straightness of the jig.

According to an embodiment the position of the pit module in the pit is adjustable with support legs comprised by the frame of the pit module.

According to an embodiment one or more intermediate modules are supported by the pit module, said intermediate modules being supported and straightened with support legs comprised by the intermediate module frame to the walls of the shaft.

According to an embodiment the car is pre-assembled in the pit module.

According to an embodiment the top module is supported by the uppermost intermediate module, said top module being supported and straightened with support legs comprised by the top module frame to the walls of the shaft.

According to an embodiment the jig frame has a rectangular shape corresponding to the horizontal cross section of a frame of the pit module.

According to an embodiment the jig frame comprises horizontal beams connected at ends to each other, preferably via corner members comprised by the jig frame.

According to an embodiment the guide means are located in corners of the jig frame, preferably in corner members comprised by the jig frame.

According to an embodiment the guide means comprise vertical guide pins and the guide means receiving members comprise recesses or holes.

According to an embodiment a support leg comprises a length adjustable mechanism such as a screw, a hinge, a lever, a hydraulic actuator or a pneumatic actuator.

Removing most of the elevator construction from the site significantly reduces construction time at site, site disruption, vehicular traffic, and improves overall safety.

### BRIEF DESCRIPTION OF THE DRAWINGS

In the following the present invention will be described in closer detail by means of preferred embodiments with reference to the attached drawings, in which:

FIG. 1 illustrates schematically a verticality of a concrete shaft for an elevator in a building,

FIG. 2 illustrates a plan of a modular elevator frame structure inside the concrete shaft,

FIG. 3 illustrates elevator modules piled on top of each other with the elevator components pre-installed in modular metal beam frames, the lowest module being placed on and supported by a positioning jig,

FIG. 4 illustrates components of an elevator without modular frames,

FIG. 5 illustrates preferred details of a passage of a suspension roping an elevator car and a counterweight,

FIG. 6 illustrates a pit module with a pre-assembled elevator car,

FIG. 7 illustrates an intermediate module,

FIG. 8 illustrates a top module,

FIG. 9 illustrates a positioning jig for positioning the elevator modules in the pit of the shaft, and

FIG. 10 illustrates in more detail the pit module placed on the positioning jig.

### DETAILED DESCRIPTION

In the building construction sector, a construction method is becoming common whereby very tall apartment blocks are built at a very fast pace from modules prefabricated in a factory, about the size of a sea container. The challenge for the elevator supplier in this type of building is that, with the traditional installation method, the installation time of the elevator becomes a bottleneck in the overall building schedule. To address this challenge, the elevator components are pre-assembled in a separate metal mounting frame formed of separate prefabricated elevator modules 2, 3, 4 which is transported and hoisted into the building in modules reducing the time spent on site from several weeks to a few days.

A vertical tolerance of a building's elevator shaft S typically varies between 10-25 mm, depending on the construction method.

Lowering a prefabricated elevator with a separate steel frame into such a shaft results in a situation where the tolerances of the steel structure 10 and the shaft are quite far apart. Typically for this type of steel structure the tolerance is in the order of 1-2 mm. Thus, due to the different tolerances, it is a challenge to position the steel structure in the correct position in a concrete or wooden shaft S. In a traditionally installed elevator, this problem has been solved by the broad adjustment margins designed into the fastening brackets. However, in a modular solution, all the components of the elevator must be able to be installed in place during the pre-assembly phase of the components, so there is no longer possibility of at least major adjustment on site.

The positioning of a modular elevator made of metal frame 10 modules in the building presents a new situation compared to a traditional elevator installation. In the traditional method, the installation starts with the shaft being plumbed to determine the optimum position of the elevator in the shaft. However, this is not possible with a modular elevator because most of the components are already located in a separate metal frame at the factory.

In the case of the modular elevator, many of the components of the elevator, such as the guide rails, are factory-assembled in the modules and are not traditionally installed in the building. Consequently, the straightness of the shaft, in accordance with the construction tolerances, cannot be taken into account during the installation of the elevator components in the modules.

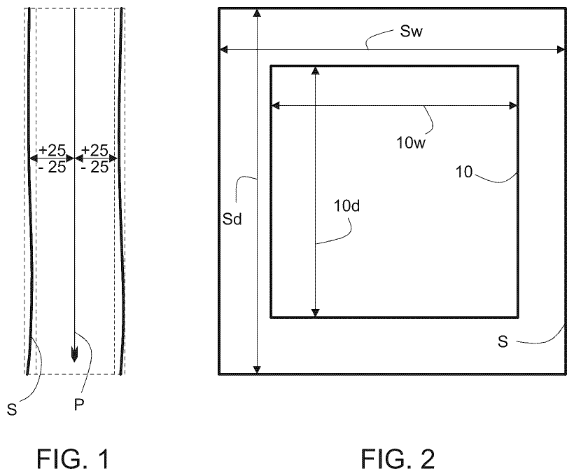

FIG. 1 shows the vertical tolerance of a concrete shaft S of +−25 mm. A plumb line is denoted with reference sign P.

FIG. 2 illustrates a plan of a modular elevator frame 10 structure inside the concrete shaft S. The width of the concrete shaft S is denoted with Sw and the depth with Sd. The width of the modular frame 10 structure is denoted with 10w and the depth with 10d.

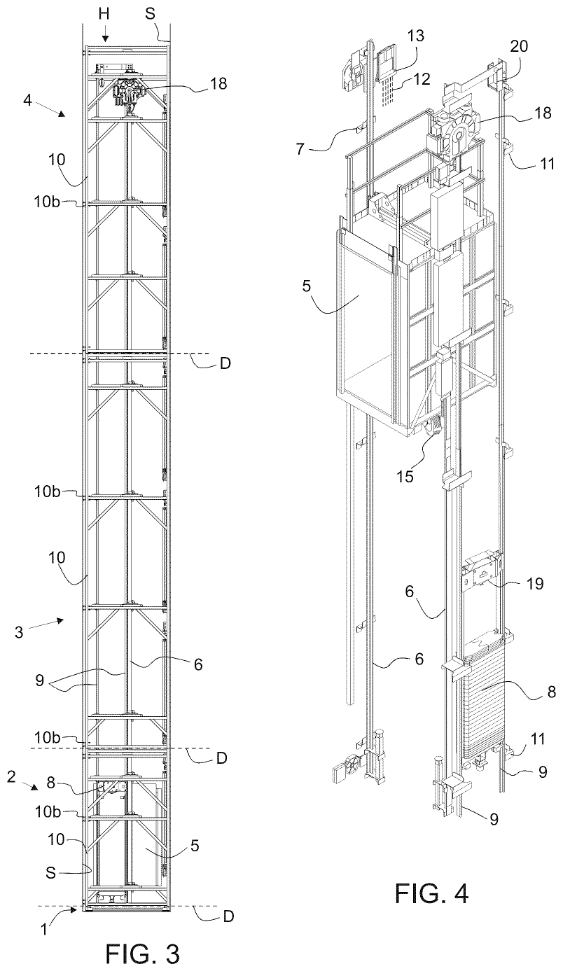

FIG. 3 shows an elevator arrangement with a positioning jig 1 and a plurality of prefabricated elevator modules 2, 3, 4 stacked on top of each other to form a uniform elevator frame, where the lowest module 2 is placed on the positioning jig 1 which is provided to guide the lowest module 2 into position relative to the shaft S. In FIG. 3 horizontal dashed lines D are drawn between separate modules 2, 3, 4 and the jig 1.

At least main components of the elevator shown in FIG. 4 are pre-assembled in said plurality of the prefabricated elevator modules 2, 3, 4, for example guide rail sections 6, 9, an elevator car 5, a counterweight 8 and an elevator hoisting machine 18.

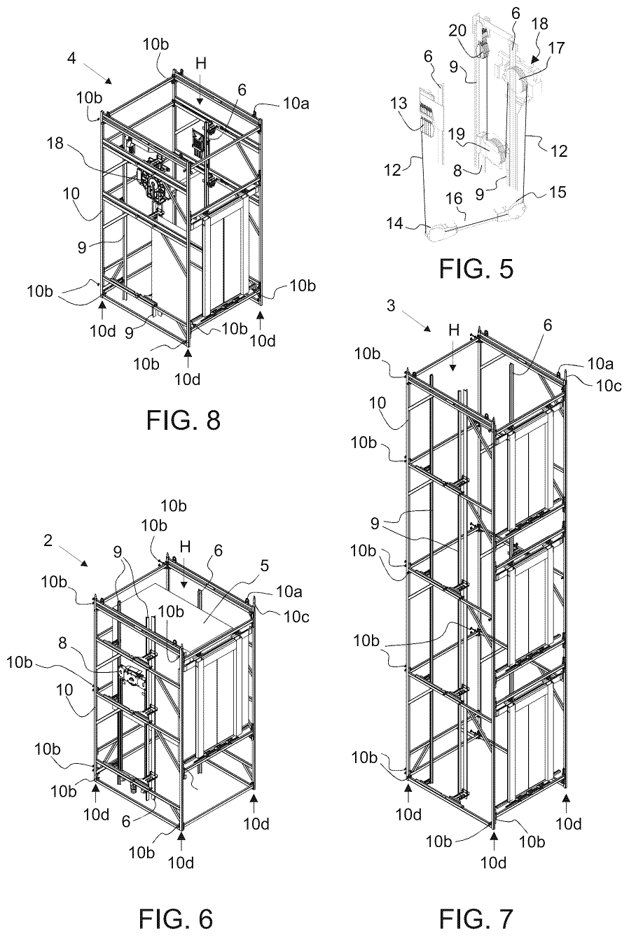

FIG. 5 illustrates preferred details of a passage of a roping 12 and a suspension of the elevator car 5 and the counterweight 8.

The plurality of prefabricated modules 2, 3, 4 comprise a prefabricated pit module 2 shown in FIG. 6, one or more prefabricated intermediate modules 3 shown in FIG. 7 (in the example of FIG. 1 one) and a prefabricated top module 4 shown in FIG. 8. The elevator car 5 is intended to move inside said prefabricated modules 2, 3, 4.

Each module 2, 3, 4 borders a hoistway space H into which the elevator car 5 or at least the upper or lower end thereof can be fitted to move. In the assembled state, said plurality of prefabricated modules 2, 3, 4 are installed on top of each other as illustrated in FIG. 3 in a shaft S of a building such that the hoistway spaces H of the prefabricated modules 2, 3, 4 are vertically aligned forming a continuous vertically elongated hoistway H where the elevator car 5 is arranged vertically movable.

Each said prefabricated module 2, 3, 4 comprises a frame 10 around the hoistway space H, which preferably tubular frame 10 forms the load-bearing structure of the module 2, 3, 4 in question. The tubularity of the frame 10 provides that it surrounds laterally the hoistway space H of the hoistway module 2, 3, 4. Tubular structure is advantageous since it increases rigidity and integrality of the individual elevator modules and rigidity and integrality of the resulting pile of modules 2, 3, 4.

In the assembled state of the elevator, the car 5 is arranged vertically movable in the hoistway H along two car guide rail lines for guiding the car 5. Each said prefabricated module 2, 3, 4 comprises guide rail sections 6 of the guide rail lines for guiding the car 5. Each said car guide rail section 6 is suitable for forming a section of a longer car guide rail line for guiding the car 5. Each said car guide rail section 6 is fixed on the tubular frame 10 with at least one fixing bracket 7. The car guide rail sections 6 of the prefabricated modules 2, 3, 4 have been positioned in the prefabricated modules such that when the modules 2, 3, 4 are piled on top of each other, the car guide rail sections 6 of the modules 2, 3, 4 become vertically aligned forming one or more (in the examples two) continuous vertical car guide rail lines for guiding the elevator car 5.

The elevator arrangement comprises a counterweight 8, wherein the whole counterweight 8 or at least an upper or lower end thereof can be fitted to move into the hoistway space H of each module 2, 3, 4. When arranging the elevator car 5 to be vertically movable in the hoistway, also the counterweight 8 is arranged to be vertically movable in the hoistway H, in particular along two counterweight guide rail lines for guiding the counterweight. Each said prefabricated module 2, 3, 4 comprises counterweight guide rail sections 9 of two guide rail lines for guiding the counterweight 8. Each said counterweight guide rail section 9 is suitable for forming a section of a longer guide rail line for guiding the counterweight 8. Each said counterweight guide rail section 9 is fixed on the tubular frame 10 with at least one fixing bracket 11. The counterweight guide rail sections 9 of the prefabricated modules 2, 3, 4 have been positioned in the prefabricated modules such that when the modules 2, 3, 4 are piled on top of each other, the counterweight guide rail sections 9 of the modules become vertically aligned forming one or more (in the examples two) continuous vertical counterweight guide rail lines for guiding the counterweight 8.

FIG. 5 shows preferred details of a passage of a suspension roping 12 for the elevator car 5 and the counterweight 8. The suspension ropes 12 pass from the first rope suspender 13 downwards to a first car pulley 14 and further horizontally to a second car pulley 15. The car pulleys may be positioned at the outer ends of a skewed pulley beam 16 extending across a sling bottom beam of the car 5. The skewed pulley beam may extend in the horizontal direction. The car 5 may thus be supported on the skewed pulley beam 16 and thereby on the suspension ropes 12 passing over the car pulleys. The suspension ropes 12 pass after the second car pulley 15 upwards to a drive wheel 17 of the elevator hoisting machine 18 and further downwards to an at least one counterweight pulley 19. The suspension ropes 12 pass after the at least one counterweight pulley 19 finally upwards to a second rope suspender 20. The counterweight 8 is hanging from the at least one counterweight pulley 19. When hoisting the pit module 2 into the shaft S, the counterweight 8 may be empty of counterweight fillers which may be inserted into a counterweight frame after hoisting the pit module in place.

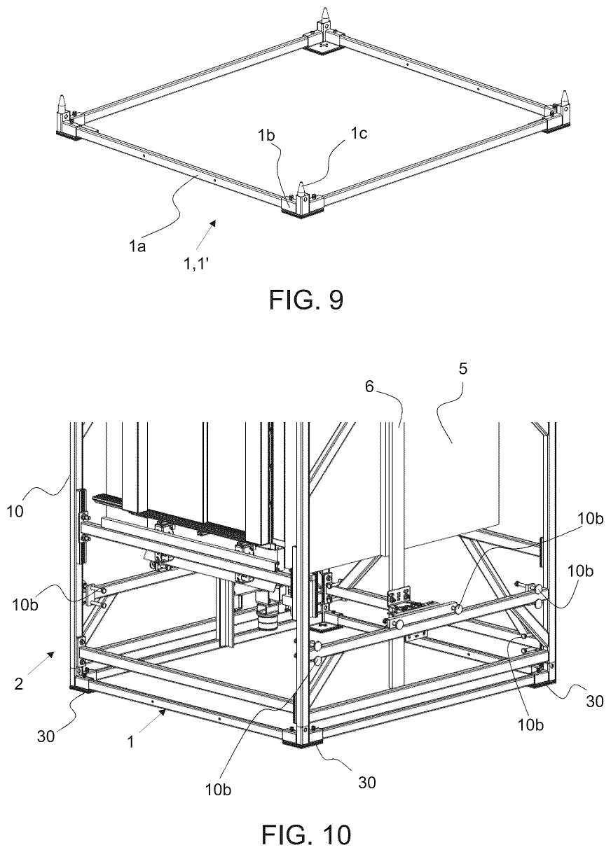

FIG. 9 shows the positioning jig 1 for positioning the elevator in a determined location in a shaft as a result of plumbing the shaft S. The jig 1 comprises a jig frame 1′ having preferably horizontally a rectangular shape corresponding to the horizontal cross section of the frame 10 of the pit module 2 and preferably the frames of the remaining modules 3, 4. The jig frame 1′ comprises horizontal beams 1a connected at ends to each other forming corners 1b, optionally directly or preferably via corner members 1b. The jig frame 1a has preferably a tubular construction.

The jig 1 comprises guide means 1c such as vertical guide pins 1c interoperating with guide means receiving members 10d such as recesses 10d or holes 10d in the bottom of the pit module 2 to guide the pit module 2 into position relating to the jig 1, and when the jig 1 is locked in the pit, laterally relating to the shaft S. Preferably the guide means 1c are located in the corners 1b of the jig 1, thus enabling using a vertical tubular beam structure of the frame 10 of the pit module 2 as a receiving counter member 10d for receiving the guide means 1c. The same applies to the guide means 10c and guide means receiving members 10d in the intermediate modules 2 and the top module 3.

Naturally the orientation of the guide means and the respective guide means receiving members may be arranged upside down, the guide means being directed downwards from the upper located module.

In the embodiment of FIG. 9 the vertical guide pins 1c protrude preferably from the corner members 1b of the jig frame 1′ and interoperate in FIG. 10 with recesses 10d such as holes 10d in the bottom of the pit module 2 to guide the pit module 2 into position with respect to the jig 1. One or more guide pins 1c may be longer than the others so that the module is guided into position in stages.

Before the elevator modules 2, 3, 4 are hoisted into the elevator shaft S, a plumbing operation is performed on the shaft S using, for example, laser plumbing tools or plumbing wires.

Once the straightness of the shaft S has been measured by the plumbing operation, the jig 1 can be moved to the bottom of the shaft S and locked in place. The jig 1 is installed at the bottom of the pit in an installation position indicated by the plumbing.

The jig 1 may be positioned at an optimum point on the bottom of the pit determined by plumbing tools such as laser plumbing tools or plumbing wires. In this way, the elevator may be positioned as close as possible to the front wall of the shaft S, while respecting other requirements.

The jig 1 may be locked in place either to the walls or to the floor of the pit by means of suitable locking means.

The straightness of the jig 1 may be determined and, if necessary, shim plates 30 are added under the jig. An appropriate thickness of shim plates may be placed under load-bearing points of the jig 1, such as a corner or corner member of the jig, to align the jig horizontally.

The hoisting of the modules 2, 3, 4 to the position specified by the jig 1 can then begin. First the pit module 2 may be hoisted onto the jig 1. Preferably the modules 2, 3, 4 are hoisted using lifting eyes 10a fixed at the top of the module frame 10.

The pit module 2 and remaining intermediate modules 3 preferably have similar guide means 10c such as guide pins 10c interoperating with guide means receiving members such as holes in the bottom of the next intermediate module 3 or top module 4 that guide the next module into the correct position. One or more guide pins 10c may be longer than the others so that the module is guided into position in stages.

The second module which is also called an intermediate module 3 may be hoisted on top of the pit module 2.

In an embodiment the car 5 is pre-assembled in the pit module 2 during hoisting the pit module 2 into the shaft S.

Preferably after hoisting the first intermediate module 3 on top of the pit module 2, the car 5 may be hoisted upwards from the pit module 2 in an upper portion of the second module 3 and locked in place. This operation may apply suitable load onto the pit module for a following position determination of the pit module.

The position of the pit module 2 may be determined in the pit and, if necessary, adjusted with support legs 10b comprised by the frame 10 of the module. Preferably the support legs 10b are horizontally adjustable. Preferably the support legs 10b are equipped with a length adjustable mechanism such as a screw or a hinge or a lever.

The pit module may be supported in the shaft S with the support legs 10b.

The other modules 3 and 4 may be hoisted into the shaft S, supported vertically by the below modules and laterally by the support legs 10b to the walls of the shaft and straightened with support legs on different sides of the frames 10.

In an embodiment the elevator hoisting machine 18 is pre-assembled in the top module 4. In an embodiment the elevator hoisting machine 18 is supported by the car guide rail 9.

The support legs 10b on different sides of the modular steel frame ensure that the steel frame 10 is supported by the building structures with sufficient force and that the elevator module stack forming the hoistway H is positioned vertically.

Preferably the support legs 10b are horizontally adjustable. Preferably the support legs 10b are equipped with a length adjustable mechanism such as a screw or a hinge or a lever. Instead of the threaded support legs 10b shown in the figures, hydraulic or pneumatic actuators can also be used. The implementation can also be anchored or cast in the shaft structure.

The invention enables making a modular lift as space-efficient as possible, breaking the tolerance chain between the building and the elevator. The elevator can be delivered as early as possible since the modules 2, 3, 4 can be produced before the whole building frame is ready.

In the application, several details have been presented as preferred. This means that they are preferred, however they are not to be understood as necessary, because it may be that the arrangement can be implemented also without them.

It is to be understood that the above description and the accompanying figures are only intended to illustrate the present invention. It will be obvious to a person skilled in the art that the invention can be varied and modified without departing from the scope of the claims.

1. A method for positioning elevator modules in a building, comprising:
providing a plurality of prefabricated elevator modules to be installed in a shaft one above the other to form an elevator module stack, the prefabricated elevator modules comprise a prefabricated pit module, one or more prefabricated intermediate modules, and a prefabricated top module,
performing a plumbing operation of the shaft,
installing said plurality of prefabricated modules such that the hoistway spaces of the prefabricated modules are vertically aligned forming a continuous vertically elongated hoistway where an elevator car can be moved vertically for transporting passengers and/or goods,
characterized by
providing a positioning jig comprising a jig frame with guide means interoperating with guide means receiving members in the bottom of the pit module for guiding the pit module into position relating to the jig and the shaft,
determining an installation position for the jig by the plumbing operation and installing the jig in the installation position in the pit of the shaft indicated by the plumbing, and
hoisting the pit module onto the jig guided by the guide means.

2. The method according to claim 1, comprising locking the jig in place to the walls or to the floor of the shaft, and/or
determining straightness of the jig and, if necessary, adding shim plates under the jig.

3. The method according to claim 1, comprising hoisting a first intermediate module onto the pit module, and supporting and straightening with support legs comprised by the intermediate module frame said first intermediate module to the walls of the shaft, and/or
wherein the car is pre-assembled in the pit module during hoisting the pit module into the shaft, and
preferably hoisting the car from the pit module in an upper portion of the first intermediate module and locking the car in place.

4. The method according to claim 1, comprising determining the position of the pit module in the pit and adjusting said position with support legs comprised by the frame of the module.

5. The method according to claim 3, comprising hoisting the remaining intermediate modules, if any, onto the first intermediate module to the position specified by the jig, and supporting and straightening with support legs comprised by the intermediate module frames said intermediate modules to the walls of the shaft.

6. The method according to claim 3, comprising hoisting the top module onto the uppermost intermediate module, and supporting and straightening with support legs comprised by the top module frame said top module to the walls of the shaft.

7. The method according to claim 1, wherein the jig frame has a rectangular shape corresponding to the horizontal cross section of a frame of the pit module, and/or
wherein the jig frame comprises horizontal beams connected at ends to each other, preferably via corner members comprised by the jig frame, and/or
wherein the guide means are located in corners of the jig frame, preferably in corner members comprised by the jig frame, and/or
wherein the guide means comprise vertical guide pins and the guide means receiving members comprise recesses or holes.

8. The method according to claim 3, comprising using as a support leg a length adjustable mechanism such as a screw, a hinge, a lever, a hydraulic actuator or a pneumatic actuator.

9. An elevator arrangement, comprising:
a plurality of prefabricated elevator modules installed in a shaft one above the other forming an elevator module stack, the prefabricated elevator modules comprising a prefabricated pit module, one or more prefabricated intermediate modules, and a prefabricated top module,
said plurality of prefabricated modules being installed after a plumbing operation of the shaft such that the hoistway spaces of the prefabricated modules are vertically aligned forming a continuous vertically elongated hoistway where an elevator car can be moved vertically for transporting passengers and/or goods,
wherein the arrangement comprises
a positioning jig comprising a jig frame with guide means interoperating with guide means receiving members comprised by the bottom of the pit module for guiding the pit module into position relating to the jig and the shaft,
the jig being installed in an installation position in the pit of the shaft determined by the plumbing, and
the pit module being guided by the guide means onto the jig and supported by the jig.

10. The arrangement according to claim 9, wherein the jig is locked in place to the walls or to the floor of the shaft, and/or
the arrangement comprises shim plates added under the jig as a result of determining straightness of the jig.

11. The arrangement according to claim 9, wherein the position of the pit module in the pit is adjustable with support legs comprised by the frame of the pit module.

12. The arrangement according to claim 9, wherein one or more intermediate modules are supported by the pit module, said intermediate modules being supported and straightened with support legs comprised by the intermediate module frame to the walls of the shaft, and/or
the car is pre-assembled in the pit module.

13. The arrangement according to claim 9, wherein the top module is supported by the uppermost intermediate module, said top module being supported and straightened with support legs comprised by the top module frame to the walls of the shaft.

14. The arrangement according to claim 9, wherein the jig frame has a rectangular shape corresponding to the horizontal cross section of a frame of the pit module, and/or
wherein the jig frame comprises horizontal beams connected at ends to each other, preferably via corner members comprised by the jig frame, and/or
wherein the guide means are located in corners of the jig frame, preferably in corner members comprised by the jig frame, and/or
wherein the guide means comprise vertical guide pins and the guide means receiving members comprise recesses or holes.

15. The arrangement according to claim 11, wherein a support leg comprises a length adjustable mechanism such as a screw, a hinge, a lever, a hydraulic actuator or a pneumatic actuator.
